(19) United States
(12) Patent Application Publication
(10) Pub. No.: US 2025/0232706 A1
(43) Pub. Date: Jul. 17, 2025

(54) BURN-IN COMPENSATION METHOD OF DISPLAY PANEL, DISPLAY CONTROL CIRCUIT AND DISPLAY DEVICE

(71) Applicant: NOVATEK MICROELECTRONICS CORP., Taiwan (CN)

(72) Inventors: Yung-Cheng Tsai, Taiwan (CN); Yao-Jen Chang, Taiwan (CN); Shang-Yu Su, Taiwan (CN); Feng-Ting Pai, Taiwan (CN)

(21) Appl. No.: 19/016,809

(22) Filed: Jan. 10, 2025

Related U.S. Application Data
(60) Provisional application No. 63/620,101, filed on Jan. 11, 2024.

(51) Int. Cl. G09G 3/20; G09G 3/3208

(52) U.S. Cl. CPC G09G 3/2092; G09G 3/3208; G09G 2310/08; G09G 2320/0233; G09G 2320/0242; G09G 2320/041; G09G 2320/046; G09G 2320/0686; G09G 2360/16

(57) ABSTRACT

A method of burn-in compensation for a display panel, a display control circuit, and a display device are provided. The method includes: performing a compensation calculation on input pixel data based on a first compensation value for the first display region, to generate output pixel data of the first display region, the first compensation value being determined based on a first accumulated burn-in stress of the first display region; sampling, based on a first sampling period, to obtain sampled pixel data of the first display region in a first sampled output frame; determining a first burn-in stress increment based on the sampled pixel data of the first display region; and generating a first updated accumulated burn-in stress based on the first accumulated burn-in stress and the first burn-in stress increment, or based on the first compensation value and the first burn-in stress increment, for updating the first sampling period.

### CROSS-REFERENCE TO RELATED APPLICATION(S)

This disclosure claims priority to and the benefit of U.S. Provisional Application No. 63/620,101, filed on Jan. 11, 2024, which is incorporated herein by reference for all purposes.

### TECHNICAL FIELD

The present disclosure relates generally to display technology field, and more particularly, to a method of burn-in compensation for a display panel, a display control circuit, and a display device.

### BACKGROUND

In a display device such as an organic light-emitting diode (OLED) display, a micro light-emitting diode (LED) display, and a liquid crystal display (LCD), the lifetime of each pixel is different depending on the color, and the light emission time of pixels at different positions on the display panel is not equal, resulting in uneven brightness and color shift of R/G/B pixels after long-term use. That is, there is a burn-in phenomenon on the display panel.

Therefore, how to prevent the occurrence of burn-in phenomenon is one of the technical issues in the art.

### SUMMARY

According to an aspect of the present disclosure, there is provided a method of burn-in compensation for a display panel, the method comprising: performing, based on a first compensation value corresponding to a first display region of the display panel, a compensation calculation on input pixel data of the first display region in an input frame, to generate output pixel data of the first display region in a burn-in-compensated output frame, wherein the first compensation value is determined based on a first accumulated burn-in stress corresponding to the first display region; sampling based on a first sampling period corresponding to the first display region, to obtain sampled pixel data of the first display region in a first sampled output frame from a plurality of burn-in-compensated output frames generated successively; determining a first burn-in stress increment based on the sampled pixel data of the first display region in the first sampled output frame; and generating a first updated accumulated burn-in stress based on the first accumulated burn-in stress and the first burn-in stress increment, or based on the first compensation value and the first burn-in stress increment, for updating the first sampling period.

According to another aspect of the present disclosure, there is also provided a display control circuit of a display panel, including a processing sub-circuit configured to: perform, based on a first compensation value corresponding to a first display region of the display panel, a compensation calculation on input pixel data of the first display region in an input frame, to generate output pixel data of the first display region in a burn-in-compensated output frame, wherein the first compensation value is determined based on a first accumulated burn-in stress corresponding to the first display region; sample based on a first sampling period corresponding to the first display region, to obtain sampled pixel data of the first display region in a first sampled output frame from a plurality of burn-in-compensated output frames generated successively; determine a first burn-in stress increment based on the sampled pixel data of the first display region in the first sampled output frame; and generate a first updated accumulated burn-in stress based on the first accumulated burn-in stress and the first burn-in stress increment, or based on the first compensation value and the first burn-in stress increment, for updating the first sampling period.

According to another aspect of the present disclosure, there is further provided a display device including a display panel and a display control circuit, the display control circuit being configured to: perform, based on a first compensation value corresponding to a first display region of the display panel, a compensation calculation on input pixel data of the first display region in an input frame, to generate output pixel data of the first display region in a burn-in-compensated output frame, wherein the first compensation value is determined based on a first accumulated burn-in stress corresponding to the first display region; sample based on a first sampling period corresponding to the first display region, to obtain sampled pixel data of the first display region in a first sampled output frame from a plurality of burn-in-compensated output frames generated successively; determine a first burn-in stress increment based on the sampled pixel data of the first display region in the first sampled output frame; and generate a first updated accumulated burn-in stress based on the first accumulated burn-in stress and the first burn-in stress increment, or based on the first compensation value and the first burn-in stress increment, for updating the first sampling period.

In the solution of burn-in compensation for the display panel according to embodiments of the present disclosure, by adjusting a sampling period or also referred to as a sampling time interval, and pro-processing, before calculating an updated accumulated burn-in stress and using an stress period gain corresponding to a sampling period, an burn-in stress original increment caused by output pixel data of a respective display region in current burn-in-compensated output frame, the burn-in stress increment or compensation increment between two sampling occasions can be better recorded under the condition that the number of data bits of a storage medium is smaller relative to the number of data bits involved in data calculation process, so that the compensation value can be more accurately calculated to improve the display effect of the display panel.

### BRIEF DESCRIPTION OF DRAWINGS

The accompanying drawings are included to provide a further understanding of the present disclosure, and are incorporated into the specification and constitute a part of the specification. The drawings illustrate embodiments of the present disclosure and, together with the description, serve to explain principles of the present disclosure.

FIG. 1 shows an example configuration of a display device including a display panel according to some embodiments of the present disclosure.

FIG. 2 shows a burn-in phenomenon in a case where a same gray scale value is applied to all pixels of the display panel after a certain time period has elapsed.

FIG. 3 shows a schematic diagram of an example process of burn-in compensation for the display panel, according to some embodiments.

FIG. 4A shows a schematic diagram of a correspondence of different number of data bits in a mapping table for a first bit mapping process, according to some embodiments of the present disclosure.

FIG. 4B shows a schematic diagram of corresponding step sizes of a part of example value ranges in FIG. 4A, according to some embodiments of the present disclosure.

FIG. 5A shows a schematic diagram of a situation in which a burn-in stress increment cannot be successfully accumulated to a previous accumulated burn-in stress according to some embodiments of the present disclosure.

FIG. 5B shows a schematic diagram of a situation in which a burn-in stress increment is successfully accumulated to a previous accumulated burn-in stress according to some embodiments of the present disclosure.

FIG. 6 shows a flow chart of a method of burn-in compensation for the display panel according to some embodiments of the present disclosure.

FIG. 7 shows a schematic diagram of an example of an operating factor according to some embodiments of the present disclosure.

FIG. 8 shows a first correspondence between accumulated burn-in stresses and compensation values based on a first mapping table.

FIG. 9 shows a schematic diagram of a second correspondence of accumulated burn-in stresses and sampling periods based on a second mapping table.

FIG. 10 shows a schematic diagram of an example process of burn-in compensation for the display panel according to some embodiments of the present disclosure.

FIG. 11 shows a schematic diagram of separately setting sampling periods for three display regions of the display panel having different accumulated burn-in stresses and sampling accordingly, according to some embodiments of the present disclosure.

FIG. 12 shows a schematic diagram of another example process of burn-in compensation for the display panel, according to some embodiments of the present disclosure.

FIG. 13A shows a schematic diagram of a situation where the burn-in stress increment does not span different accumulated burn-in stress ranges, according to some embodiments of the present disclosure.

FIG. 13B shows a schematic diagram of a situation where the burn-in stress increment spans different accumulated burn-in stress ranges, according to some embodiments of the present disclosure.

### DETAILED DESCRIPTION

It is to be understood that other embodiments may be utilized and structural changes may be made without departing from the scope of the present disclosure. Furthermore, it is to be understood that the phraseology and terminology used herein are for the purpose of description and should not be regarded as limiting. The use of “comprising”, “comprising” or “having” and variations thereof herein is intended to encompass the items listed hereinafter and their equivalents, as well as additional items. Unless otherwise limited, the term “connection” and variations thereof herein are used broadly and encompass direct and indirect connections, and may include electrical or physical connections.

Throughout the present disclosure, ordinal numbers (e.g., first, second, third, etc.) may be used as adjectives for elements (i.e., any noun in the present disclosure). The use of ordinal numbers is not intended to imply or create any particular ordering of elements, nor is it intended to limit any element to only a single element, unless explicitly disclosed, such as by the use of the terms “before”, “after”, “single” and other such terms. Instead, the use of ordinal numbers is intended to distinguish between elements. For example, the first element is different from the second element, and the first element may comprise more than one element and be after (or before) the second element when ordering elements.

In order to prevent burn-in phenomenon of various display panels and to prolong the life of pixels, the present disclosure proposes a display device and a method of burn-in compensation for the display panel thereof. It should be noted that the application of the present disclosure is mainly described by taking an organic light-emitting diode (OLED) panel as an example, but is not limited to an OLED panel, and other display panels such as a liquid-crystal display (LCD) panel, a light-emitting diode (LED) display panel, a mini-LED display panel, a micro-LED display panel, an electronic paper, a plasma display, and the like can adopt the technology of the present disclosure.

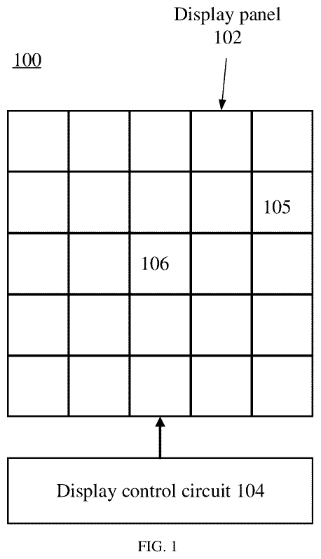

FIG. 1 shows an example configuration of a display device including a display panel according to some embodiments of the present disclosure.

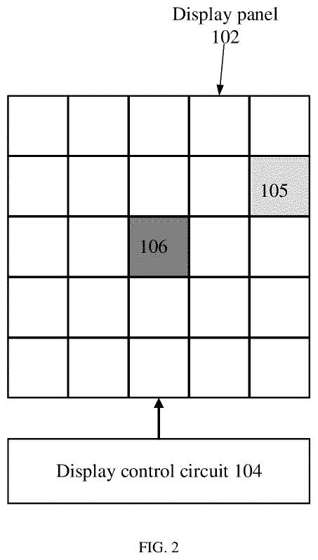

The display panel 102 includes a plurality of display regions (non-overlapping, and a minimum unit of these display regions may be one pixel). Examples of the display panel 102 may include an OLED display panel, a micro LED display panel, and an LCD panel. In the illustrated embodiment, the plurality of display regions of the display panel 102 include a first display region 105 and a second display region 106, and the accumulated burn-in stresses of the first display region 105 and the second display region 106 are not necessarily the same, which is mainly caused by factors such as different light emission durations (corresponding to use durations) and different display pixel data of each display region. For example, when the pixels in the second display region 106 are displayed for a longer time than the pixels in the first display region 105, after a certain time period, when pixel data of a same gray scale value is applied to all pixels of the display panel, as shown in FIG. 2, the brightness of the second display region 106 is lower than that of the first display region 105, that is, different degrees of burn-in phenomenon appear on the display panel, so it is necessary to compensate the brightness of the first display region 105 and the second display region 106 respectively. The display panel 102 may be connected to a display control circuit 104, which is configured to update display data of respective display regions of the display panel 102.

According to some embodiments of the present disclosure, in order to compensate the brightness of respective pixels on the display panel or respective pixels in preset display regions to avoid or reduce the burn-in phenomenon, sampling and recording can be performed regularly to accumulate and obtain the accumulated burn-in stresses caused by pixel data of respective pixels (or respective pixels in respective display regions), and the accumulated burn-in stresses may be converted into compensation values according to a preset mapping relationship for compensating the pixel data for respective pixels or respective pixels in respective display regions of the current image frame, thereby reducing the brightness difference caused by different degrees of burn-in phenomenon. Of course, it is also possible to compensate only the pixel data for a part of pixels or for pixels of a part of display regions, for example, by setting an accumulated burn-in stress threshold value to select the pixels or the display regions to be compensated.

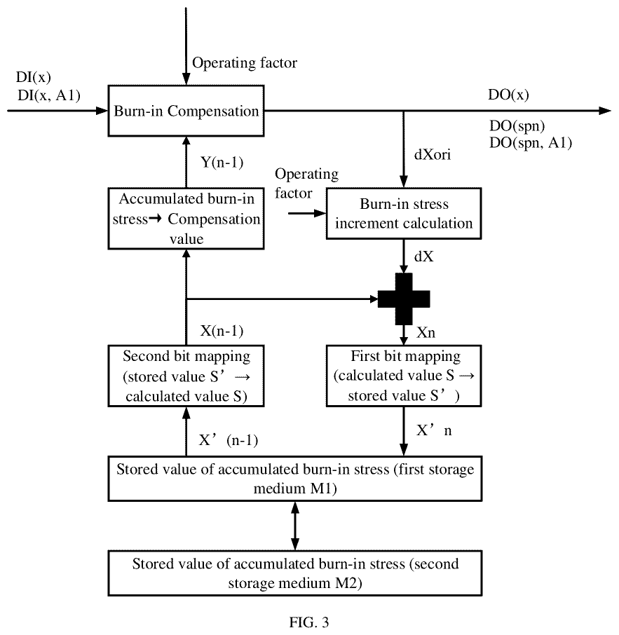

For example, FIG. 3 shows a schematic diagram of an example process of burn-in compensation for a display panel, according to some embodiments. As shown in FIG. 3, input pixel data DI(x, A1) (e.g., a data value or gamma code) of a first display region in each input frame DI(x) of successive input frames may first be acquired. As previously described, the first display region may include a single pixel or a plurality of pixels, so when a plurality of pixels are included, the input pixel data of the first display region may be pixel data associated with (e.g., an average, median, or otherwise associated value of) the input pixel data of the plurality of pixels. Then, according to a compensation value Y(n−1) corresponding to the first display region, burn-in-compensated output pixel data of the first display region in a plurality of burn-in-compensated output frames DO(x) that are generated successively are obtained. The compensation value Y(n−1) corresponding to the first display region is a compensation value corresponding to the accumulated burn-in stress X(n−1) updated after the display of the sampled pixel data DO(sp(n−1), A1) of the first display region in the sampled burn-in compensated output frame DO(sp(n−1)) which is referred to as the sampled output frame for short and obtained at the (n−1)-th sampling. For example, for a specific batch or a specific type of display panels, a mapping relationship of a plurality of reference accumulated burn-in stresses corresponding to a plurality of reference compensation values may be measured and recorded in advance, for example by means of a mapping table. In this way, after the accumulated burn-in stress X(n−1) is obtained, the corresponding compensation value Y(n−1) can be determined from this mapping relationship, for example by means of interpolation, as will be described in detail later.

Then, a sampled output frame DO(spn) (obtained at the n-th sampling) and the sampled pixel data DO(spn, A1) of the first display region thereof are sampled based on a first sampling period and from the plurality of burn-in-compensated output frames DO(x) generated successively, to calculate an burn-in stress original increment dXori caused by the sampled pixel data DO(spn, A1) of the first display region in the sampled output frame DO(spn) and determine, according to a fixed sampling period and an optional operating factor, a burn-in stress increment dX in the sampling period. The burn-in stress increment dX is added to current latest accumulated burn-in stress X(n−1) to obtain Xn. Next, the accumulated burn-in stress of the first display region is recorded and updated in a first storage medium M1 for updating the compensation value of the first display region. Since the use of the display device may be intermittent, the display control circuit is turned off after the end of one use, and therefore, in order to avoid data loss, the accumulated burn-in stress of the first display region in the first storage medium M1 may be stored in the second storage medium M2, and the first storage medium M1 needs to read the accumulated burn-in stress of the first display region from the second storage medium M2 again when it is necessary to use the accumulated burn-in stress in the first display region, for example, for calculating a compensation value for input pixel data in the first display region of an input frame.

Therefore, in the compensation solution shown in FIG. 3, the sampling period (i.e., the sampling time interval) for sampling respective image frames is fixed, for example, the time length of the sampling period may be the time length of one frame or of more frames. However, this compensation solution based on fixed sampling period will have certain problems.

For example, the first storage medium M1 typically employs a fast, low-power cache, for example, static random access memory (SRAM) may be employed, and the second storage medium M2 may employ a memory capable of retaining data after a power failure, such as a FLASH memory. However, in order to save the storage space of the memory and thereby reduce the cost and arrangement space, and the like, a first number of data bits on which the data processing of the display control circuit for calculating the accumulated burn-in stress (which may be collectively referred to as data calculation process) is based is generally larger than a second number of data bits of data accessed through the first storage medium and the second storage medium. That is, storing the calculated accumulated burn-in stress to the storage medium (first storage medium and second storage medium) involves a first bit mapping process (as S-S′ mapping shown in FIG. 3), and using the accumulated burn-in stress read from the storage medium for calculating the compensation value involves a second bit mapping process (as S′-S mapping shown in FIG. 3). Since the effect of the accumulated burn-in stress on brightness is non-linear, for different value ranges (i.e., different ranges of the accumulated burn-in stress), corresponding step sizes on which the data calculation process performed by the display control circuit is based are different, which may lead to a situation in which a small burn-in stress increment dX for a certain sampling period cannot be successfully accumulated to a previous accumulated burn-in stress.

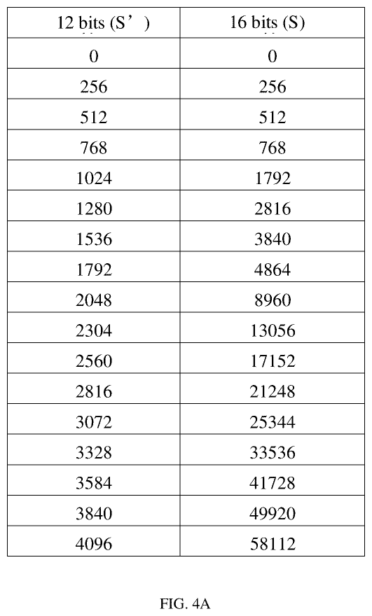

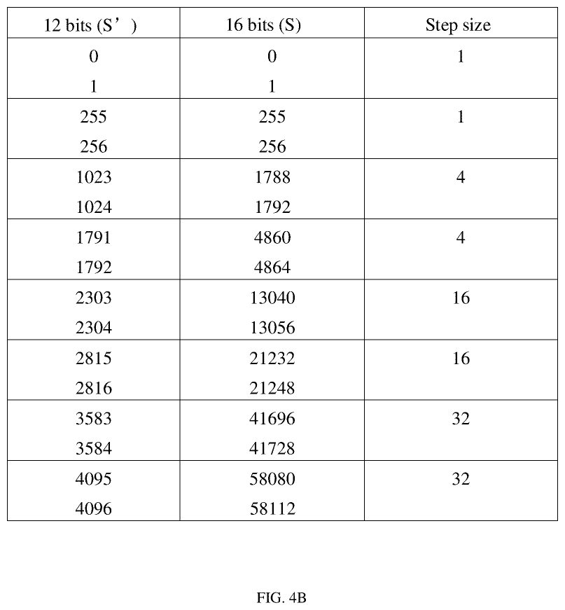

FIG. 4A shows a schematic diagram of a correspondence between different number of data bits (for representing reference accumulated burn-in stresses) in a mapping table for the first bit mapping process, according to some embodiments of the present disclosure. FIG. 4B shows a schematic diagram of corresponding step sizes of a part of example value ranges in FIG. 4A. FIG. 5A shows a schematic diagram of a situation in which a burn-in stress increment cannot be successfully accumulated to a previous accumulated burn-in stress. FIG. 5B shows a schematic diagram of a situation in which a burn-in stress increment is successfully accumulated to a previous accumulated burn-in stress.

In FIG. 4A, as an example, it is assumed that the first number of data bits on which the data calculation process (including calculating the accumulated burn-in stress) performed by the display control circuit is based is 16, and the second number of data bits of the storage medium is 12. Both the 12 bits of the storage medium and the 16 bits on which the data calculation process performed by the display control circuit is based should be able to represent entire value range of the accumulated burn-in stress. Meanwhile, since when the accumulated burn-in stress is small, a variation magnitude of a corresponding compensation value is large, and when the accumulated burn-in stress is large, the variation magnitude of the corresponding compensation value is small (as exemplarily shown in Table 2 below), the range of smaller bit values of the 16-bit accumulated burn-in stress can be represented by more data resources that can be represented by 12 bits. Further, in FIG. 4A, bit values not shown between two adjacent 12-bit reference accumulated burn-in stresses in the mapping table for the first bit mapping process are uniformly used to represent bit values not shown between corresponding two adjacent 16-bit reference accumulated burn-in stresses.

The correspondence between only a part of 12-bit accumulated burn-in stresses (as the 12-bit reference accumulated burn-in stresses) and a part of 16-bit accumulated burn-in stresses (as the 16-bit reference accumulated burn-in stresses) is shown in FIG. 4A and FIG. 4B, it can be seen that there are approximately two thousand 16-bit accumulated burn-in stresses (0 to 1792) mapped to approximately 1000 12-bit accumulated burn-in stresses (0 to 1024). However, there are approximately 20,000 16-bit accumulated burn-in stresses (41696 to 58112) mapped to only about 500 12-bit accumulated burn-in stresses (3583 to 4096).

Therefore, in the example correspondence of FIG. 4A and FIG. 4B, for the 16-bit accumulated burn-in stress, the larger the value the larger the corresponding step size. For example, for the 12-bit accumulated burn-in stress, when its value needs to be progressed from 4094 to 4095, its corresponding 16-bit accumulated burn-in stress needs to be increased by 32 (step size), that is, a burn-in stress increment dX calculated for one sampling period needs to be large enough for the stored value in the storage medium (12 bits) to also reflect the change in burn-in degree. For example, when the burn-in stress increment dX (16 bits) is less than the step size corresponding to the current latest accumulated burn-in stress (16 bits), the accumulated burn-in stress updated after the current latest accumulated burn-in stress plus the burn-in stress increment dX cannot result in the change in the 12-bit accumulated burn-in stress after the first bit mapping process S-S′ mapping (from 16 bits to 12 bits), so that the accumulated burn-in stress stored in the storage medium cannot accurately present the actual burn-in degree of the display panel.

A specific example is shown in FIG. 5A. When the sampling period is 1 second, the burn-in stress increment within each sampling period determined based on the output pixel data of the first display region in each sampled output frame can be expressed as 1, and although the updated 16-bit accumulated burn-in stress calculated after each sampling changes by 1 (for example, 21232→21233), the 12-bit accumulated burn-in stress stored in the storage medium after the first bit mapping process (S-S′ mapping) is always 2815, and fails to change to 2816 accordingly. When the accumulated burn-in stress 2815 is read from the storage medium for calculating the next compensation value, it is mapped again to 21232 after the second bit mapping process (S′-S mapping), and the mapping processes are repeated. As a result, the accumulated burn-in stress of the first display region stored in the storage medium after the S-S′ mapping cannot accurately present the actual burn-in degree of the first display region on the display panel, and the calculated compensation value cannot be well used to compensate the burn-in phenomenon of the first display region on the display panel.

The above problem can be solved by adjusting the sampling period or also referred to as a sampling time interval, and before calculating the updated accumulated burn-in stress, using an stress period gain corresponding to the sampling period to pre-process a burn-in stress original increment caused by the sampled pixel data of the current sampled output frame in the first display region, so as to solve the problem that the small burn-in stress increment cannot be accurately accumulated. As shown in FIG. 5B, assuming that for a time period, the burn-in stress original increment caused by the output pixel data of the first display region in each sampled output frame obtained with the sampling period of 1 second is used to calculate the burn-in stress original increment within the sampling period, and the burn-in stress original increment is always 1, then in a case where the adjusted sampling period is 16 seconds and the stress period gain is set to 16, the burn-in stress increment 1 within 1 second can be multiplied by the stress period gain (16) (or regarded as multiplied by the ignored (unsampled) sample number of times (15) plus 1) to obtain the adjusted burn-in stress increment 16. Therefore, the 16-bit accumulated burn-in stress calculated after sampling can be increased by 16 (e.g., 21232 →21248), and the 12-bit accumulated burn-in stress X′n stored in the storage medium mapped by the first bit mapping process (S-S′ mapping) can be successfully increased to 2816. When the 12-bit accumulated burn-in stress 2816 is read from the storage medium for calculating the next compensation value, it is mapped again to 16-bit accumulated burn-in stress 21248 after the second bit mapping process (S′-S mapping), and the determination of a new compensation value and a new sampling period may similarly continue. The above processes are repeated. In this way, the accumulated burn-in stress stored in the storage medium after the S-S′ mapping can accurately present the actual burn-in degree of the first display region on the display panel, and the calculated compensation value can also be well used to compensate the burn-in phenomenon of the first display region on the display panel.

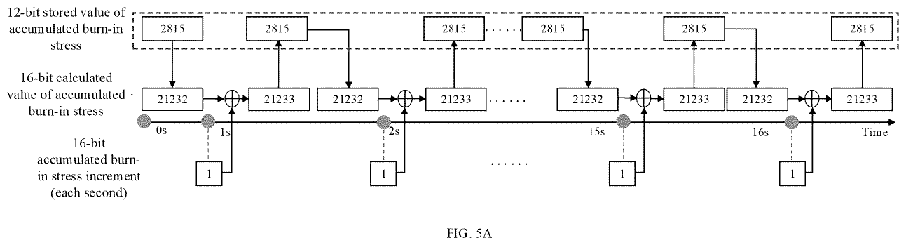

Based on this solution, aspects of a solution for determining the accumulated burn-in stress by adjusting the sampling period and using it for burn-in compensation for the display panel will be described in detail below with reference to FIG. 6 to FIG. 13B.

FIG. 6 is a schematic flowchart of a method of burn-in compensation for a display panel according to some embodiments of the present disclosure. The method may be performed by the display control circuit in FIG. 1.

As shown in FIG. 6, in step S610, compensation calculation is performed, based on a first compensation value corresponding to a first display region of the display panel, on input pixel data of the first display region in an input frame, to generate output pixel data of the first display region in a burn-in compensated output frame, where the first compensation value is determined based on a first accumulated burn-in stress corresponding to the first display region.

For example, the first display region may be an entire display region of the display panel, a partial display region of the display panel, or a display region corresponding to one pixel of the display panel. That is, the smallest unit of the first display region is a region corresponding to one pixel.

During use of the display panel, the burn-in stress of each pixel will gradually accumulate from the display of the ordinal first input frame, and the accumulated burn-in stress can be used to determine a compensation value to compensate for the brightness of the pixel. Alternatively, the accumulated burn-in stress may be stored in a storage medium and continuously updated, or in other embodiments, the compensation value may be stored in the storage medium and continuously updated. Hereinafter, an embodiment in which the storage medium stores the accumulated burn-in stress will be described first.

For example, after obtaining the input pixel data DI(x, A1) of the input frame DI (x) in the first display region, an accumulated burn-in stress corresponding to the first display region, expressed as a first accumulated burn-in stress X(n−1), may be acquired (i.e., the current sampling number of times for the first display region is n, and the first accumulated burn-in stress X(n−1) represents the accumulated burn-in stress of the first display region updated after the end of the previous sampling (i.e., (n−1)-th sampling), and the first compensation value Y(n−1) for the first display region is determined according to the first accumulated burn-in stress. For example, the first compensation value Y(n−1) corresponding to the first accumulated burn-in stress X(n−1) may be determined according to a preset functional relationship between accumulated burn-in stresses and compensation values. For another example, a first compensation value Y(n−1) corresponding to the first accumulated burn-in stress X(n−1) may be determined based on a first mapping table, where the first mapping table records a mapping relationship of a plurality of reference accumulated burn-in stresses corresponding to a plurality of reference compensation values.

For example, when determining the first compensation value based on the first mapping table, an interpolation algorithm may be utilized. For example, the plurality of reference accumulated burn-in stresses (Xr0, Xr1, Xr2 . . . , XrM, where M is 2 or more) and the plurality of reference compensation values (Yr0, Yr1, Yr2 . . . , YrM) corresponding one-to-one to the plurality of reference accumulated burn-in stresses are known, and the compensation value changes linearly with the accumulated burn-in stress within the accumulated burn-in stress range between every two reference accumulated burn-in stresses. Therefore, when determining the first compensation value according to the first accumulated burn-in stress, an accumulated burn-in stress range corresponding to the first accumulated burn-in stress may be determined, where the accumulated burn-in stress range includes a first endpoint and a second endpoint, the first endpoint has a first reference accumulated burn-in stress (assumed to be Xr0) and a corresponding first reference compensation value Yr0, the second endpoint has a second reference accumulated burn-in stress (assumed to be Xr1) and a corresponding second reference compensation value Yr1, and the first accumulated burn-in stress X(n−1) is interposed between the first reference accumulated burn-in stress Xr0 and the second reference accumulated burn-in stress Xr1. The first compensation value Y(n−1) may then be determined based on the first reference accumulated burn-in stress Xr0 and the corresponding second reference compensation value Yr0, the second reference accumulated burn-in stress Xr1 and the corresponding second compensation value Yr1, and the first accumulated burn-in stress X(n−1), e.g. Y(n−1)=Yr0+(Yr1-Yr0)*(X(n−1)−Xr0)/(Xr1−Xr0).

In this case, Table 1 illustrates an example of the first mapping table according to an embodiment of the present disclosure. In this first mapping table, the mapping relationship in which the plurality of reference accumulated burn-in stresses (16 bits) correspond to the plurality of reference compensation values are shown. The first mapping table may be obtained by testing one display panel as a standard in advance, and the obtained first mapping table may be used as a reference for other display panels of the same type. The first mapping table in Table 1 shows an example of the plurality of reference compensation values corresponding to the plurality of reference accumulated burn-in stresses (16 bits), but the first mapping table may also include more, fewer, and/or different reference accumulated burn-in stresses and their corresponding reference compensation values. Through the first mapping table, after the first accumulated burn-in stress is acquired, the accumulated burn-in stress range can be found from the first mapping table, and the corresponding first compensation value can be calculated. Optionally, for the same display panel, the first mapping tables for different colors (for example, Red/Green/Blue) of pixels are also different.

TABLE 1

| Accumulated burn-in stress | |
|---|---|
| (16 bits) | Compensation value |
| 0 | 0 |
| 256 | 5 |
| 512 | 10 |
| 768 | 15 |
| 1792 | 16.25 |
| 2816 | 17.5 |
| 3840 | 18.75 |
| 4864 | 20 |
| 8960 | 20.3125 |
| 13056 | 20.625 |
| 17152 | 20.9375 |
| 21248 | 21.25 |
| 25344 | 21.5625 |
| 33536 | 21.71875 |
| 41728 | 21.875 |
| 49920 | 22.03125 |
| 58112 | 22.1875 |

Optionally, as described above, each accumulated burn-in stress may be represented and processed in a first number of data bits (such as 16 bits described above), and each accumulated burn-in stress is mapped and converted into a second number of data bits (such as 12 bits described above) less than the first number to be stored in the storage medium to reduce the storage space of the storage medium. When determining the first compensation value corresponding to the first display region, the stored value of the first accumulated burn-in stress having the second number of data bits may be read from the storage medium, and then the stored value of the first accumulated burn-in stress may be converted to obtain the first accumulated burn-in stress represented by the first number of data bits, and then used to determine the first compensation value. Further, as previously described with reference to FIG. 4A, there is a correspondence between the 12-bit accumulated burn-in stresses and the 16-bit accumulated burn-in stresses, and a range of smaller bit values of the 16-bit accumulated burn-in stress are represented using more data resources of 12 bits.

In step S620, sampling is performed based on a first sampling period corresponding to the first display region, to obtain sampled pixel data of the first display region in a first sampled output frame from a plurality of burn-in-compensated output frames generated successively.

Since there are a plurality of burn-in-compensated output frames (not sampled) generated successively during the display process, for example, when the first sampling period is 5 seconds and the frame rate is 60 fps, there may be 300 burn-in-compensated output frames within the first sampling period of 5 seconds. However, since these burn-in-compensated output frames need not be sampled, the first accumulated burn-in stress X(n−1) is not updated, and the output pixel data in the first display region of each of these burn-in-compensated output frames is still compensated using the first compensation value Y(n−1) for the first display region determined based on the first accumulated burn-in stress X(n−1), until the sampled pixel data DO(spn, A1) in the first display region in the first sampled output frame DO(spn) is sampled (assuming it is the n-th sampling) in response to the expiration of the first sampling period.

For example, for input pixel data DI(x, A1) of the first display region in each input frame, when the input pixel data is compensated based on a respective first compensation value Y(n−1), the first compensation value Y(n−1) may be multiplied by an operating factor to obtain an adjusted compensation value, where the operating factor may be associated with one or more of: a display panel attribute, an environmental impact factor, and a driving performance. The output pixel data DO(x, A1) of the first display region in the burn-in-compensated output frame may then be obtained based on the adjusted compensation value for the first display region and the input pixel data DI(x, A1) of the first display region.

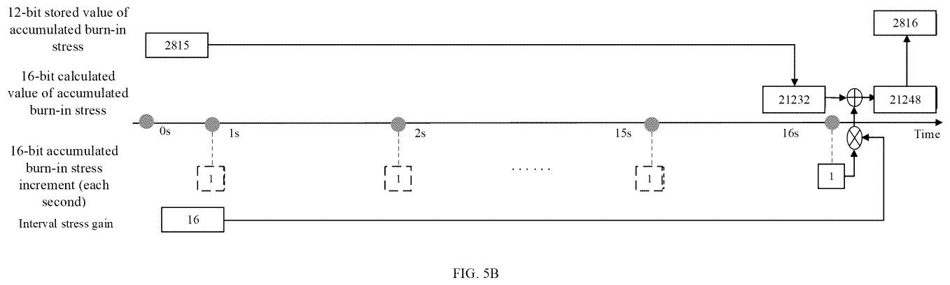

As an example, a display Brightness value (DBV), which is an example of the display panel attribute, has a mapping relationship with a brightness gain (DBV_gain), a temperature value, which is an example of the environmental influence factor, has a mapping relationship with a temperature gain (Temp_gain), and a frame rate (Hz_gain), which is an example of the driving performance, has a mapping relationship with a frame rate gain. Thus, as shown in FIG. 7, the product of these three gains may be as an operating factor, and multiplied by the first compensation value Y(n−1) to obtain the adjusted compensation value.

In step S630, a first burn-in stress increment is determined based on the sampled pixel data of the first display region in the first sampled output frame.

For example, as previously described, the output pixel data of the first display region in each burn-in-compensated output frame (the first sampled output frame is sampled) results in an increase in the burn-in stress of the first display region, and for each sampling period, the output pixel data of the first display region in each burn-in-compensated output frame within the sampling period results in a same or similar burn-in stress original increment dXori, however, if the burn-in stress original increment dXori is small, the small burn-in stress cannot be recorded for a long time. Accordingly, the first burn-in stress original increment dXori may be determined based on the sampled pixel data DO(spn, A1) of the first display region in the first sampled output frame DO(spn) (e.g. may be based on a conversion relationship between RGB values and burn-in stresses well known in the art), the first burn-in stress original increment dXori is then multiplied by a first ratio (i.e., the stress period gain described above) to obtain the first burn-in stress increment dX, where the first ratio is positively related to the time length of the first sampling period, because the number of output frames included in the first sampling period depends on the time length of the first sampling period. For example, the first sampling period may be a multiple of the time length of one frame.

Additionally, the operational factor (associated with one or more of: the display panel attribute, the environmental impact factor, and the driving performance) as described above may also optionally be taken into account. Typically, the operating factor may be greater than 1. Accordingly, the first ratio is also associated with the operating factor.

In step S640, a first updated accumulated burn-in stress is generated based on the first accumulated burn-in stress and the first burn-in stress increment, for updating the first sampling period.

For example, the first accumulated burn-in stress X(n−1) and the first burn-in stress increment dX may be added to obtain the first updated accumulated burn-in stress X(n).

Then, as previously described, each accumulated burn-in stress is represented and processed in a first number of data bits, and each accumulated burn-in stress is stored in a storage medium after being mapped into a stored value of a second number of data bits less than the first number (S-S′ mapping). When the compensation value needs to be determined, the current accumulated burn-in stress needs to be obtained from the storage medium, and therefore, the stored value having a second number of data bits needs to be read from the storage medium, and a mapping process (S′-S mapping) of converting the stored value having the second number of data bits into a calculated value having the first number of data bits. In order to avoid a situation where a smaller value of the burn-in stress increment within the sampling period is not successfully recorded (as described above in FIG. 5A), the sampling period may be set to be variable (as described above in FIG. 5B). Accordingly, after each update of the accumulated burn-in stress, the sampling period may be updated and used to determine a next sampling occasion, so as to sample a new sampled output frame at the next sampling occasion for the plurality of burn-in-compensated output frames generated successively. Further, after each time the accumulated burn-in stress is updated, the calculated value of the updated accumulated burn-in stress having the first number of data bits may be converted into the stored value of the updated accumulated burn-in stress having the second number of data bits (S-S′ mapping), and the stored value of the updated accumulated burn-in stress may be stored in the storage medium.

As previously mentioned, introducing the variable sampling period is primarily aimed at enabling the new burn-in stress increment dX to be accurately recorded. According to some embodiments of the present application, the variable sampling period may be determined according to a second mapping table. The second mapping table records a mapping relationship of a plurality of reference accumulated burn-in stresses corresponding to a plurality of sampling periods.

The second mapping table may be designed according to variation magnitudes of compensation values which correspond to accumulated burn-in stresses. Table 2 shows bit values of the second number of data bits (12 bits), compensation values (Offset), and variation magnitudes of the compensation values (dOffset), corresponding to several bit values of the first number of data bits (16 bits) used to represent the accumulated burn-in stress.

TABLE 2

| | | | Variation |
|---|---|---|---|
| | | | magnitude |
| Accumulated | Accumulated | | of |
| burn-in | burn-in | Compensation | compensation |
| stress | stress | value | value |
| (12 bits) | (16 bits) | (Offset) | (dOffset) |
| 0 | 0 | 0 | 5 |
| 256 | 256 | 5 | 5 |
| 512 | 512 | 10 | 5 |
| 768 | 768 | 15 | 1.25 |
| 1024 | 1792 | 16.25 | 1.25 |
| 1280 | 2816 | 17.5 | 1.25 |
| 1536 | 3840 | 18.75 | 1.25 |
| 1792 | 4864 | 20 | 0.3125 |
| 2048 | 8960 | 20.3125 | 0.3125 |
| 2304 | 13056 | 20.625 | 0.3125 |
| 2560 | 17152 | 20.9375 | 0.3125 |
| 2816 | 21248 | 21.25 | 0.3125 |
| 3072 | 25344 | 21.5625 | 0.15625 |
| 3328 | 33536 | 21.71875 | 0.15625 |
| 3584 | 41728 | 21.875 | 0.15625 |
| 3840 | 49920 | 22.03125 | 0.15625 |
| 4096 | 58112 | 22.1875 | |

It can be seen that after the second number of data bits of the storage medium and the first number of data bits on which the data calculation process involved in the display control process is based are selected, as described above with reference to FIG. 4A and FIG. 4B, it is necessary to reasonably allocate data resources in the storage medium to different value ranges of the first number of data bits, which makes it possible to represent a range of smaller values of the accumulated burn-in stress (represented by the first number of data bits) using more data resources (bit values) that can be represented by the second number of data bits, so as to make more accurate compensation.

Furthermore, since the variation magnitude of the compensation value corresponding to each value (in the sense of each accumulated burn-in stress) of the first number of data bits may be different, and if the variation magnitude of the compensation value is large, it may be desirable to perform sampling more frequently, and a smaller sampling period is required in this case. On the contrary, if the variation magnitude of the compensation value is small, sampling can be performed more slowly, in which case a larger sampling period can be used to save power. Accordingly, when the first accumulated burn-in stress changes to the first updated accumulated burn-in stress, the larger the variation magnitude of the corresponding first compensation value, the smaller sampling period which the first sampling period is updated to.

Therefore, the second mapping table can be designed based on the correspondence between the accumulated burn-in stresses and variation magnitudes of compensation value, as shown in Table 3. The columns of the compensation value and the variation magnitude of compensation value in Table 3 are shown in order to clearly explain the correspondence between the sampling periods and the variation magnitudes of compensation value, and the actual second mapping table may not include these two columns. In Table 3, for each 16-bit reference accumulated burn-in stress in Table 1, there is a corresponding accumulated burn-in stress range, and the minimum value of each accumulated burn-in stress range is a corresponding reference accumulated burn-in stress.

TABLE 3

| Minimum | Maximum | | | |
|---|---|---|---|---|
| value | value | | | |
| of | of | | Variation | Sampling |
| accumulated | accumulated | | magnitude | period |
| burn-in | burn-in | | of | (Step Size/ |
| stress | stress | Compensation | compensation | Stress |
| range | range | value | value | period |
| (16 bits) | (16 bits) | (Offset) | (dOffset) | Gain) |
| 0 | 255 | 0 | 5 | 1 |
| 256 | 511 | 5 | 5 | 1 |
| 512 | 767 | 10 | 5 | 1 |
| 768 | 1791 | 15 | 1.25 | 4 |
| 1792 | 2815 | 16.25 | 1.25 | 4 |
| 2816 | 3839 | 17.5 | 1.25 | 4 |
| 3840 | 4863 | 18.75 | 1.25 | 4 |
| 4864 | 8959 | 20 | 0.3125 | 16 |
| 8960 | 13055 | 20.3125 | 0.3125 | 16 |
| 13056 | 17151 | 20.625 | 0.3125 | 16 |
| 17152 | 21247 | 20.9375 | 0.3125 | 16 |
| 21248 | 25343 | 21.25 | 0.3125 | 16 |
| 25344 | 33535 | 21.5625 | 0.15625 | 32 |
| 33536 | 41727 | 21.71875 | 0.15625 | 32 |
| 41728 | 49919 | 21.875 | 0.15625 | 32 |
| 49920 | 58111 | 22.03125 | 0.15625 | 32 |
| 58112 | | 22.1875 | | |

It can be seen that, in the second mapping table, the reference accumulated burn-in stress corresponding to a larger variation magnitude of compensation value (a difference between a next compensation value and the current compensation value in Table 3) corresponds to a smaller sampling period, and the reference accumulated burn-in stress corresponding to a smaller variation magnitude of compensation value corresponds to a larger sampling period. Further, for the accumulated burn-in stress within each accumulated burn-in stress range, it corresponds to the same sampling period as the sampling period corresponding to a smallest accumulated burn-in stress within (i.e., the corresponding reference accumulated burn-in stress of) the accumulated burn-in stress range. For example, if the first accumulated burn-in stress is 234, the sampling period corresponding to the first accumulated burn-in stress is 1, which corresponds to the reference accumulated burn-in stress 0, and if the first accumulated burn-in stress is 23366, the sampling period corresponding to the first accumulated burn-in stress is 16, which corresponds to the reference accumulated burn-in stress 21248.

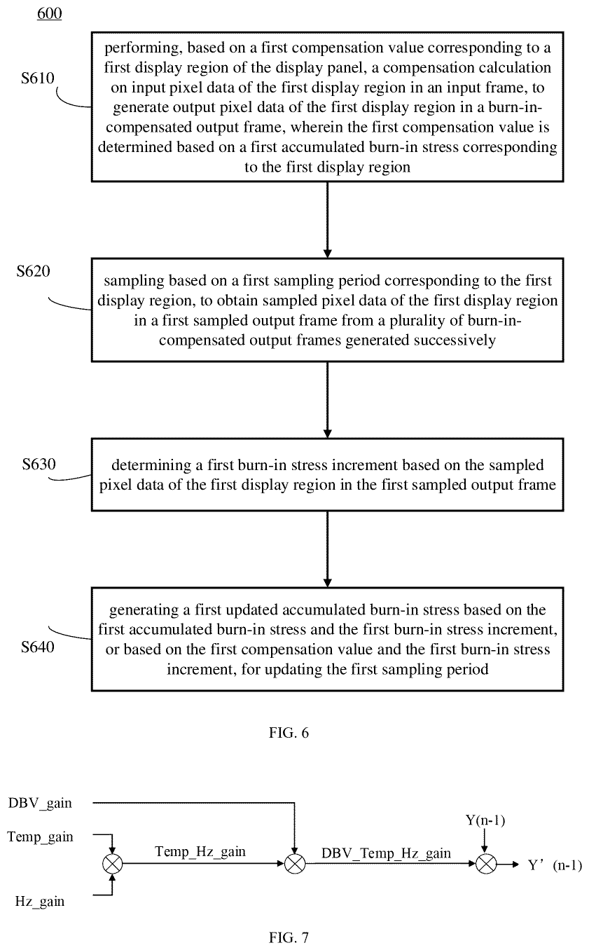

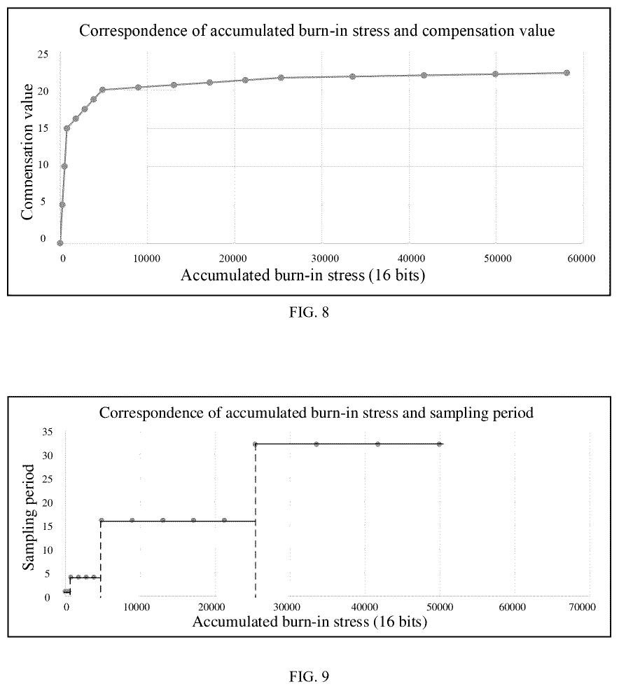

FIG. 8 shows a first correspondence between accumulated burn-in stresses and compensation values based on the first mapping table, and FIG. 9 shows a schematic diagram of a second correspondence of accumulated burn-in stresses and sampling periods based on the second mapping table.

As shown in FIG. 8, the first correspondence between accumulated burn-in stresses and compensation values may be composed of a plurality of line segments, and two endpoints of each line segment have two reference accumulated burn-in stress and two corresponding compensation values. Consistent with the second mapping table, when the accumulated burn-in stress is relatively small, the compensation value increases rapidly, and the slope of the line segment is large, and when the accumulated burn-in stress is relatively large, the variation of the compensation value is relatively gentle, and the slope of the line segment is small. The continuous line segments as shown in FIG. 8 indicate that the corresponding compensation value can be calculated by interpolation based on the calculated accumulated burn-in stress.

As shown in FIG. 9, consistent with the second mapping table, when the accumulated burn-in stress is relatively small, the variation magnitude of the compensation value is relatively large, and thus the sampling period is relatively small, and when the accumulated burn-in stress is relatively large, the variation of the compensation value is relatively gentle, and thus the sampling period is relatively large. Furthermore, as can be seen from FIG. 9, the corresponding sampling period can be determined as long as the accumulated burn-in stress is known.

The counting unit of the sampling period in the second mapping table is a predetermined multiple (for example, 1 or more times) of the time length of one frame, for example, 1 in the second mapping table represents 1 counting unit and 4 represents 4 counting units. Further, since the time length of each sampling period corresponds to the time length of a plurality of frames, the burn-in stress increment in the sampling period is the product of the burn-in stress original increment dXori caused by the sampled pixel data of the first display region in the sampled output frame and a ratio (positively related with the time length of the sampling period), the updatable sampling period in the present disclosure can also be understood as being used for the stress period gain. Additionally, the burn-in stress original increment dXori caused by the sampled pixel data of the first display region in the sampled output frame is derived from the RGB values of the sampled pixel data and according to a conversion relationship well known in the art, and there is a minimum value of the burn-in stress original increment dXori dependent on different sampled pixel data. When the sampling period is one counting unit, it is necessary to ensure that even a minimum value of the burn-in stress increment obtained from the minimum value of the burn-in stress original increment can be successfully recorded for the sampling period, therefore the sampling period corresponding to one counting unit may be the time length required by the situation that for the minimum value of the burn-in stress original increment dXori, the 16-bit accumulated burn-in stress updated based on the 16-bit burn-in stress increment dX, after storing, can make the 12-bit stored value of the accumulated burn-in stress increase by 1. Based on the setting of the sampling period in the second mapping table, it is possible to accurately record the burn-in stress increment for each sampling period. For example, when the first accumulated burn-in stress is 18000, the stored value thereof in the storage medium is 2613, and the corresponding first sampling period is 16 counting units. The first burn-in stress increment over the first sampling period is at least 16 (it can be greater than 16 when considering the operating factor or when the burn-in stress original increment dXori is relatively large), the first updated accumulated burn-in stress is at least 18016, and the stored value thereof in the storage medium becomes at least 2614, so that the first burn-in stress increment can be successfully recorded.

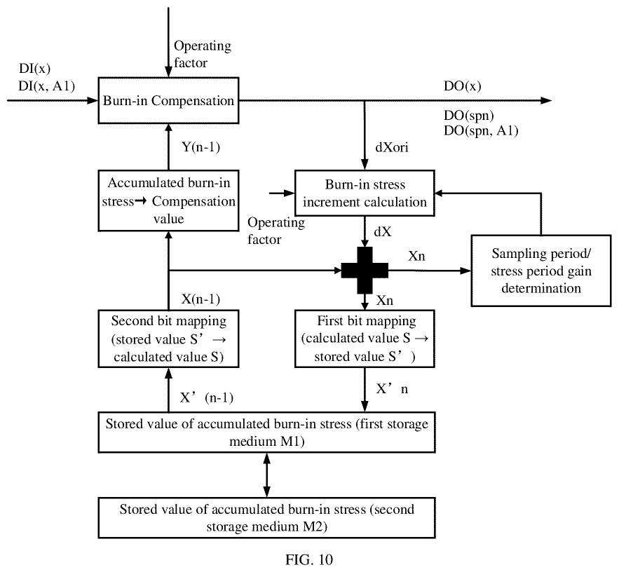

Hereinafter, an example process of burn-in compensation for the display panel according to some embodiments of the present disclosure will be described as an example with reference to FIG. 10.

For example, the burn-in-compensated sampled pixel data DO(sp(n−1), A1) of the first display region in the (n−1)-th sampled output frame DO(sp(n−1)) has been displayed, and the accumulated burn-in stress X(n−1) (16 bits) of the first display region updated after displaying the sampled output pixel data DO(sp(n−1), A1) has been stored into the storage medium (12 bits) through S-S′ mapping, the stored value being denoted X′(n−1). This accumulated burn-in stress X(n−1) is used for successively generating a plurality of burn-in-compensated output frames DO(x) for successive input frames DI(x), for example, it is necessary to read the stored value of the current accumulated burn-in stress X′(n−1) (12 bits) of the first display region from the storage medium and convert it to the accumulated burn-in stress X(n−1) (16 bits) through S′-S mapping. Furthermore, it is necessary to determine the required first compensation value Y(n−1) based on the accumulated burn-in stress X(n−1) of the first display region by using the first mapping table. Furthermore, for the accuracy of the compensation, an operating factor (as previously described) is also considered, and an adjusted compensation value is obtained based on the required first compensation value Y(n−1) and the operating factor for compensating the input pixel data DI(x, A1) of the first display region in each input frame, resulting in the burn-in-compensated output pixel data of the first display region in the output frame for display.

When the burn-in-compensated sampled pixel data DO(spn), A1) of the first display region in the n-th sampled output frame DO(spn) is acquired based on the first sampling period from the plurality of burn-in-compensated output frames DO(x) successively generated based on the accumulated burn-in stress X(n−1), because the burn-in-compensated output pixel data of the first display region in each output frame will cause the change in burn-in stress of the display panel, the corresponding burn-in stress original increment dXori may be determined based on the sampled pixel data DO(spn, A1), and the first burn-in stress increment dX of the first display region within the first sampling period may be obtained by combining the burn-in stress original increment dXori, the first sampling period previously updated according to the accumulated burn-in stress X(n−1) and using the second mapping table, and the optional operating factor. Adding the first burn-in stress increment dX and the first accumulated burn-in stress X(n−1) can obtain the first updated accumulated burn-in stress of the first display region, as the accumulated burn-in stress Xn of the first display region after displaying the burn-in-compensated sampled pixel data DO(spn, A1) of the first display region in the n-th sampled output frame DO(spn).

After obtaining the latest accumulated burn-in stress Xn (16 bits) of the first display region, it may be used to update the first sampling period to obtain a first update sampling period so as to sample output frames after the first update sampling period has elapsed, and repeatedly perform the above processes of compensation value calculation, first burn-in stress increment calculation within the first update sampling period, and further update of the first update sampling period. For example, when updating the first sampling period, the first sampling period may be updated according to the second mapping table.

Similarly, after the latest accumulated burn-in stress Xn (16 bits) of the first display region is obtained, it needs to be stored in the storage medium (12 bits) through S-S′ mapping, and the stored value is denoted as X′n for subsequent use.

Therefore, with the method of burn-in compensation for a display panel according to the embodiments of the present disclosure, by adjusting the sampling period or also referred to as the sampling time interval, and before calculating the updated accumulated burn-in stress, pre-processing the burn-in stress original increment caused by the burn-in-compensated output pixel data of a respective display region in the current output frame using the stress period gain corresponding to the sampling period, the burn-in stress increment between two sampling occasions can be better recorded under the condition that the number of data bits of a storage medium is smaller relative to the number of data bits involved in data calculation process, so that the compensation value can be more accurately calculated to improve the display effect of the display panel.

Further, as previously described, the display panel may include a plurality of display regions (the smallest unit of the display region may be one pixel), and the output pixel data of each display region may be different for each burn-in compensated output frame, so that each display region has a respective accumulated burn-in stress, and thus the sampling period may be independently adjusted for each display region according to the respective accumulated burn-in stress. Different accumulated burn-in stresses correspond to different sampling periods.

Therefore, according to some embodiments of the present disclosure, the method 600 may further include the steps of: performing, based on a second compensation value Y⁽²⁾(m−1) (obtained by an update after the (m−1)-th sampling) corresponding to a second display region of the display panel, the compensation calculation on input pixel data DO(x, A2) of the second display region in the input frame DI(x), to generate output pixel data DO(x, A2) of the second display region in the burn-in-compensated output frame, where the second compensation value Y⁽²⁾(m−1) is determined based on a second accumulated burn-in stress X⁽²⁾(m−1) corresponding to the second display region; sampling based on a second sampling period corresponding to the second display region, to obtain sampled pixel data DO(spm, A2) of the second display region in a second sampled output frame DO(spm) (an output frame obtained by the m-th sampling) from the plurality of burn-in-compensated output frames generated successively; determining a second burn-in stress increment dX⁽²⁾ based on the sampled pixel data DO(spm, A2) of the second display region in the second sampled output frame DO(spm); and generating a second updated accumulated burn-in stress X⁽²(m) based on the second accumulated burn-in stress X⁽²⁾(m−1) and the second burn-in stress increment dX⁽²⁾, for updating the second sampling period, where the first sampling period corresponding to the first display region and the second sampling period corresponding to the second display region are set separately.

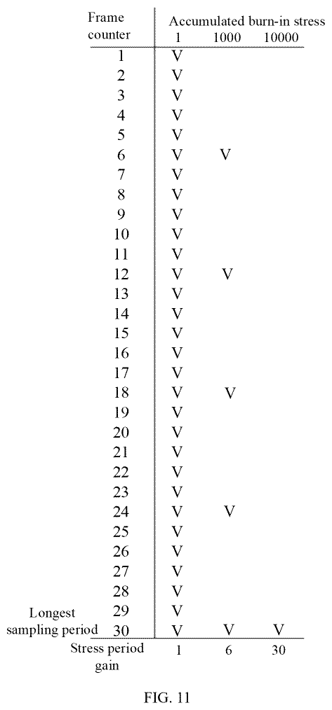

For example, FIG. 11 shows a schematic diagram of separately setting sampling periods for three display regions of the display panel having different accumulated burn-in stresses (1, 1000, and 10000, respectively) and sampling accordingly.

As previously described, the second mapping table may be used to determine the sampling period corresponding to each display region, and different accumulated burn-in stresses correspond to different sampling periods. For example, it is assumed that according to a preset second mapping table (representing the correspondence between accumulated burn-in stresses and sampling periods), in a display region where the accumulated burn-in stress is equal to 10000, the burn-in stress increment dX needs to be greater than or equal to 30 to make the stored value X′n in the storage medium increase by 1, and in a display region where the accumulated burn-in stress is equal to 1, the burn-in stress increment dX only needs to be greater than or equal to 1 to make the stored value X′n in the storage medium increase by 1. In the above situation, if the same sampling period is used for all display regions, the longest sampling period (for example, the time length of 30 frames in the assumption of the burn-in stress original increment dXori caused by each output frame being 1), that is, the sampling period corresponding to the display region having the accumulated burn-in stress of 10000, should be selected, so that the burn-in stress increment of each display region within the sampling period is large enough to achieve progression.

However, if all display regions of the display panel are sampled only once after a sampling period of at least 30 frames, for example, for two display regions having accumulated burn-in stresses of 1 and 1000, their accumulated burn-in stresses also vary within the sampling period, but are not used for compensation in time because they are not sampled, so the accuracy of burn-in compensation of these two display regions is sacrificed and the final display effect is affected.

Therefore, for example, each display region uses a sampling period suitable for itself, for example, greater than or equal to the time length of 1 frame, greater than or equal to the time length of 6 frames, and greater than or equal to the time length of 30 frames, and it is assumed that the respective burn-in stress original increment dXori caused by output pixel data of each display region in each burn-in-compensated output frame is the same, for example 1. In this way, for the display region having an accumulated burn-in stress 1, the burn-in stress increment dX caused after a sampling period of more than or equal to the time length of one frame is at least 1, and the stored value X′n can be increased by at least 1 when stored in the storage medium. For a display region having an accumulated burn-in stress of 1000, the burn-in stress increment dX caused after a sampling period of more than or equal to the time length of 6 frames is at least 6, and the stored value X′n can be increased by at least 1 when stored in the storage medium. Of course, for a display region having an accumulated burn-in stress of 10000, the burn-in stress increment dX caused after a sampling period of more than or equal to the time length of 30 frames is at least 30, and the stored value X′n can be increased by at least 1 when stored in the storage medium. Therefore, it can be ensured that the burn-in stress increment within the respective sampling period of each display region can be accurately recorded and used to determine the compensation value.

Further, in the example shown in FIG. 11, the time lengths of respective sampling periods for the respective display regions may be factors/multiples of each other (e.g., 1, 6, and 30, respectively, or 2, 12, and 48, respectively), so that the longest sampling period can be matched using a fastest counter (for counting image frames), and the accumulated burn-in stresses can be updated once at the same time after each longest sampling period is completed, thereby updating the sampling periods once at the same time, and the problem of crossing of the respective sampling periods can be avoided.

In the above-described embodiments, the accumulated burn-in stress being stored in the storage medium is described as an example. In other embodiments, as described above, the compensation value may be stored in the storage medium instead of the accumulated burn-in stress, so that when it is necessary to perform compensation calculation on input pixel data of the input frame in one or more display regions, the currently stored compensation value may be directly read from the storage medium.

Therefore, in this case, the method described in FIG. 6 may further comprise the step of: reading the first compensation value Y(n−1) from the storage medium to perform the compensation calculation on the input pixel data (D(x, A1) of the first display region in the input frame DI(x).

In addition, when generating the first updated accumulated burn-in stress in step S640, the first updated accumulated burn-in stress Xn may alternatively be generated based on the first compensation value Y(n−1) and the first burn-in stress increment dX, for updating the first sampling period. For example, the first accumulated burn-in stress X(n−1) corresponding to the first compensation value Y(n−1) may be determined based on the first mapping table, where the first mapping table records a mapping relationship of a plurality of reference accumulated burn-in stresses corresponding to a plurality of reference compensation values as described above, for example, as in Table 1. Then, the first accumulated burn-in stress X(n−1) and the first burn-in stress increment dX are added to obtain the first updated accumulated burn-in stress Xn for updating the first sampling period.

In addition, the first compensation value needs to be updated to be stored in the storage medium, for example, a first updated compensation value Yn may be generated based on the first compensation value Y(n−1) and the first burn-in stress increment dX.

For example, based on the first compensation value Y(n−1), two reference compensation values (Y1, Y0) between which the first compensation value Y(n−1) is located may be obtained from the first mapping table, and two reference accumulated burn-in stresses (X1, X0) corresponding to the two reference compensation values (Y1, Y0) may be obtained. The first mapping table records the mapping relationship of the plurality of reference accumulated burn-in stresses corresponding to the plurality of reference compensation values. Then, the first compensation increment dY may be determined based on the first burn-in stress increment dX, the acquired two reference compensation values (Y1, Y0), and the acquired two reference accumulated burn-in stresses (X1, X0), and the first compensation value Y(n−1) and the first compensation increment (dY) is added to obtain the first updated compensation value Yn.

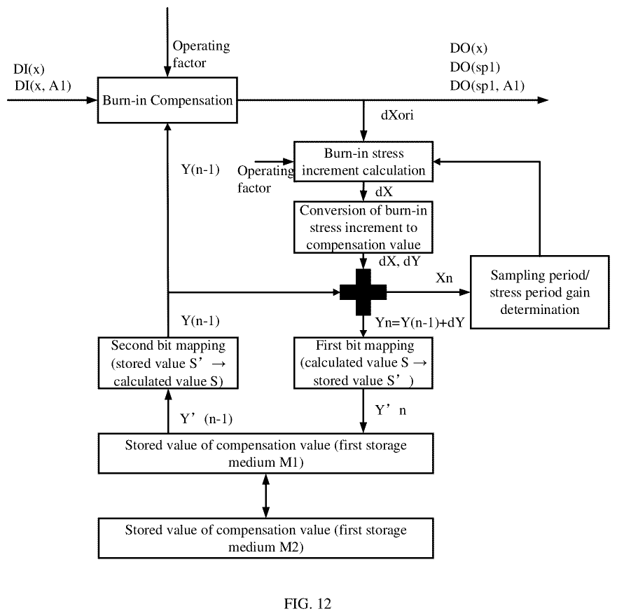

For example, in connection with another example process of burn-in compensation for the display panel (the storage medium stores the compensation value) according to some embodiments of the present disclosure shown in FIG. 12, the burn-in compensated sampled pixel data DO(sp(n−1), A1) of the first display region in the (n−1)-th sampled output frame DO(sp(n−1)) has been displayed, and the first compensation value Y(n−1) updated after displaying the sampled pixel data DO(sp(n−1), A1) is stored in the storage medium after S→S′ mapping and recorded as Y′(n−1). The first compensation value Y(n−1) is used to successively generate a plurality of burn-in-compensated output frames DO(x) for successive input frames DI(x). For example, a 12-bit stored value Y′ (n−1) of the current first compensation value for the first display region needs to be read from the storage medium and converted to the 16-bit first compensation value Y(n−1) by S′-S mapping. Furthermore, for the accuracy of the compensation, an operating factor (as previously described) is also considered, and an adjusted compensation value is obtained based on the required first compensation value Y(n−1) and the operating factor, for compensating the input pixel data DI(x, A1) of the first display region in each input frame, resulting in the burn-in-compensated output pixel data of the first display region in the output frame for display.

When the burn-in-compensated sampled pixel data DO(spn), A1) of the first display region in the n-th sampled output frame DO(spn) is acquired based on the first sampling period from the plurality of burn-in-compensated output frames DO(x) successively generated based on the first compensation value Y(n−1), because the burn-in-compensated output pixel data of the first display region in each output frame will cause the change in burn-in stress of the display panel, the corresponding burn-in stress original increment dXori may be determined based on the sampled pixel data DO(spn, A1). The first burn-in stress increment dX of the first display region within the first sampling period can be obtained by combining the burn-in stress original increment dXori, the first accumulated burn-in stress X(n−1) obtained according to the first compensation value Y(n−1) and using the first mapping table, the first sampling period updated according to the first accumulated burn-in stress X(n−1) and using the second mapping table, and an optional operating factor. Adding the first burn-in stress increment dX and the first accumulated burn-in stress X(n−1) can obtain the updated accumulated burn-in stress (the first updated accumulated burn-in stress) of the first display region, which serves as the accumulated burn-in stress Xn of the first display region after displaying the burn-in-compensated sampled pixel data DO(spn), A1) of the first display region in the n-th sampled output frame DO(spn), for updating the first sampling period.

In addition, the process of updating the first sampling period according to the first updated accumulated burn-in stress Xn is similar to the previous process, for example, the first sampling period is updated based on the second mapping table. For example, as shown in the first mapping table, the plurality of reference compensation values correspond to the plurality of reference accumulated burn-in stresses, and between every two reference accumulated burn-in stresses, the compensation value may be considered to be linearly changing, so that the accumulated burn-in stresses and the compensation values may be considered to be one-to-one correspondence, so that the first number of data bits and the second number of data bits of the storage medium may be used to represent each compensation value. That is, even in the case where the sampling period is updated according to the updated accumulated burn-in stress, it is ensured that the compensation increment dY in each sampling period can be accurately recorded.

Then, since it is also necessary to determine the first update compensation value Yn for storage, the first compensation increment dY may be determined from the known first burn-in stress increment dX, and the first update compensation value Yn may be determined based on the first compensation value Y(n−1) and the first compensation increment dY. The first update compensation value may be stored in the storage medium after by S-S′ mapping.

For example, in the process of calculating the first compensation increment dY from the first burn-in stress increment dX, the plurality of reference accumulated burn-in stresses (X0, X1, X2 . . . ) and the plurality of reference compensation values (Y0, Y1, Y2 . . . ) corresponding one-to-one to the plurality of reference accumulated burn-in stresses in the first mapping table are known, and within an accumulated burn-in stress range between every two reference accumulated burn-in stresses (e.g., between X0 and X1, between X1 and X2), the compensation value changes linearly with the accumulated burn-in stress. Therefore, when the current latest first compensation value Y(n−1) and the first burn-in stress increment dX of the first display region are known, it is possible to determine a compensation value range and a corresponding accumulated burn-in stress range in which the first compensation value is located.

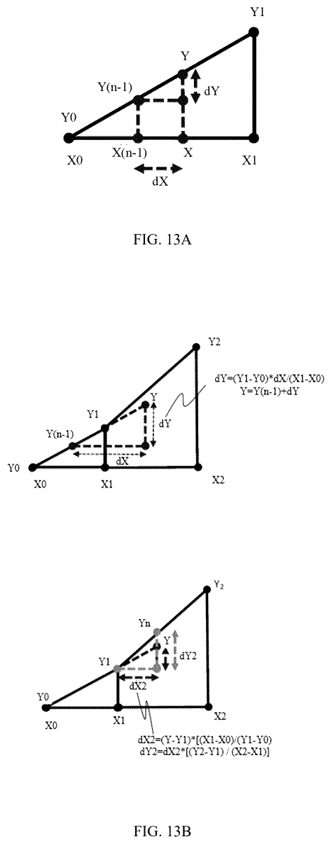

As shown in FIG. 13A, if the first burn-in stress increment dX does not span different accumulated burn-in stress ranges, that is, the added value of the first accumulated burn-in stress X(n−1) corresponding to the first compensation value Y(n−1) plus the first burn-in stress increment dX is located in a second accumulated burn-in stress range which is the same as the accumulated burn-in stress range (the endpoints of the range are two reference accumulated burn-in stress) corresponding to the compensation value range (the endpoints of the range are two reference compensation values) in which the first compensation value Y(n−1) is located, and the first compensation increment dY can be determined based on the first burn-in stress increment, the two reference accumulated burn-in stresses, and the two reference compensation values.

For example, in FIG. 13A, the first compensation value Y(n−1) is located between Y0 and Y1 (known), and the added value of X(n−1) and dX is still between X0 and X1, then dY=(Y1−Y0)*dX/(X1−X0), and the first updated compensation value is Yn=Y(n−1)+dY.

Since different accumulated burn-in stress ranges may correspond to different slopes of the corresponding line segment between two range endpoints, as shown in FIG. 13B, if the first burn-in stress increment dX spans different accumulated burn-in stress ranges, that is, the added value of the first accumulated burn-in stress X(n−1) corresponding to the first compensation value Y(n−1) plus the first burn-in stress increment dX is located in a second accumulated burn-in stress range different from the accumulated burn-in stress range corresponding to the compensation value range in which the first compensation value Y(n−1) is located (where the second accumulated burn-in stress range may correspond to two reference accumulated burn-in stresses, and the two accumulated burn-in stress ranges may be adjacent or not adjacent), the first compensation increment may be determined based on the first compensation value, the first burn-in stress increment, the two reference accumulated burn-in stresses and the two corresponding reference compensation values, and the two reference accumulated burn-in stresses and the two corresponding reference compensation values of the second accumulated burn-in stress range. After obtaining the first compensation increment, the first compensation increment may be added to the reference compensation value at the smaller range endpoint of the compensation value range corresponding to the second accumulated burn-in stress range, to obtain a final first updated compensation value.

In the method of FIG. 13B, two adjacent ranges are described as an example (a similar method can be used in a case where they are not adjacent ranges), and the first compensation value dY2 can be calculated according to the following process:
dY=(Y1-Y0)*dX/(X1-X0) is calculated based on the slope of the first line segment, thus Y=Y(n−1)+dY;
dY2=dX2*[(Y2-Y1)/(X2-X1)] is calculated based on the slope of the second line segment;

Since dX2=(Y−Y1)*[(X1-X0)/(Y1-Y0)], it can be obtained that dY2=dX2*[(Y2−Y1)/(X2−X1)]=(Y−Y1)*[(X1−X0)/(Y1−Y0)]*[(Y2−Y1)/(X2−X1)].

Therefore, the first update compensation value Yn=Y1+dY2.

Finally, based on the first update compensation value, the first sampling period is updated as the first update sampling period.

Further, in such a solution of burn-in compensation for the display panel according to the embodiments of the present disclosure (the storage medium stores the compensation value), different sampling periods may be set for similar display regions, and the sampling periods of different display regions may be factors/multiples of each other. Optionally, the manner of setting the sampling period for each display region is similar to that described above, and the description will not be repeated here.

Therefore, based on this solution, by adjusting the sampling period or also referred to as the sampling time interval, and before calculating the updated accumulated burn-in stress, pre-processing the burn-in stress original increment caused by the burn-in-compensated output pixel data of a respective display region in the current output frame using the stress period gain corresponding to the sampling period, the compensation increment between two sampling occasions can be better recorded under the condition that the number of data bits of a storage medium is smaller relative to the number of data bits involved in data calculation process, so that the compensation value can be more accurately calculated to improve the display effect of the display panel.

According to another aspect of the present disclosure, there is further provided a display control circuit for controlling a display operation of a display panel.

The display control circuit according to embodiments of the present disclosure may be the display control circuit 104 as shown in FIG. 1. In some embodiments, the display panel may also be integrated with a touch function to constitute a display touch panel, and/or integrated with a touch function and a fingerprint recognition function, so that the display control circuit may be used to control the execution of the corresponding function accordingly. The display control circuitry may include circuitry for performing processing to generate various signals for the display panel, and may include one or more circuitry, such as a display driving circuit, a timing control circuit, and/or a touch detection circuit, and the like, one or more of which may be packaged as an integrated circuit (IC) chip.

The display panel may be connected to the display control circuit, and the display control circuit may be configured to update display data of the display panel. As described above, the burn-in phenomenon may exist on the display panel, and compensation for the burn-in phenomenon on the panel needs to be made, and thus the display control circuit may be configured to perform various steps in the method of burn-in compensation for the display panel as described above. Further, since the display panel may be divided into a plurality of display regions (the minimum unit is one pixel), and since the display data and the use time of each display region may be different, the burn-in phenomenon of each display region may also be different, the display control circuit may be configured to perform burn-in compensation separately for each display region.

Optionally, the display control circuit may include a processing sub-circuit and a storage medium (for example, SRAM and FLASH), the processing sub-circuit may perform various calculation processes, and the calculated result (for example, the accumulated burn-in stress or the compensation value) may be stored in the storage medium. The processing sub-circuit may read corresponding data from the storage medium when it is needed to be used later.

For example, the processing sub-circuit in the display control circuit may be configured to: perform, based on a first compensation value corresponding to a first display region of the display panel, a compensation calculation on input pixel data of the first display region in an input frame, to generate output pixel data of the first display region in a burn-in-compensated output frame, wherein the first compensation value is determined based on a first accumulated burn-in stress corresponding to the first display region; sample based on a first sampling period corresponding to the first display region, to obtain sampled pixel data of the first display region in a first sampled output frame from a plurality of burn-in-compensated output frames generated successively; determine a first burn-in stress increment based on the sampled pixel data of the first display region in the first sampled output frame; and generate a first updated accumulated burn-in stress based on the first accumulated burn-in stress and the first burn-in stress increment, or based on the first compensation value and the first burn-in stress increment, for updating the first sampling period.

Further details of the operation performed by the display control circuit can be referred to in the foregoing description, and the description will not be repeated herein.

Therefore, with the display control circuit according to the embodiments of the present disclosure for compensating the burn-in phenomenon of the display panel, by adjusting a sampling period or also referred to as a sampling time interval, and pro-processing, before calculating an updated accumulated burn-in stress and using an stress period gain corresponding to the sampling period, an burn-in stress original increment caused by output pixel data of a respective display region in current burn-in-compensated output frame, the burn-in stress increment or compensation increment between two sampling occasions can be better recorded under the condition that the number of data bits of a storage medium is smaller relative to the number of data bits involved in data calculation process, so that the compensation value can be more accurately calculated to improve the display effect of the display panel.

According to another aspect of the present disclosure, there is also provided a display device.

The display device according to embodiments of the present disclosure may be the display device as shown in FIG. 1. For example, the display device may include a display panel and a display control circuit. The display panel may perform a display operation under the control of the display control circuit. In some embodiments, the display panel may also be integrated with a touch function to constitute a display touch panel, and/or a touch function and a fingerprint recognition function may be integrated, and the display control circuit may be used to control the execution of the corresponding function accordingly. The display control circuit may include circuitry for performing processing to generate various signals for the display panel, and may include one or more circuitry, such as a display driving circuit, a timing control circuit, a touch detection circuit, and the like, one or more of which may be packaged as an integrated circuit (IC) chip.

The display panel may be connected to the display control circuit, and the display control circuit may be configured to update display data of the display panel. As described above, a burn-in phenomenon may exist on the display panel, and compensation for the burn-in phenomenon on the panel needs to be made, and thus the display control circuit may be configured to perform various steps in the method of burn-in compensation for the display panel as described above. Further, the display panel may be divided into a plurality of display regions (the minimum unit is one pixel), and since the display data and the use time of each display region may be different, the burn-in phenomenon of each display region may also be different, and thus the burn-in compensation may be performed separately for each display region.

Optionally, the display control circuit may include a processing sub-circuit and a storage medium (for example, SRAM and FLASH), the processing sub-circuit may perform various calculation processes, and the calculated result (for example, the accumulated burn-in stress or the compensation value) may be stored in the storage medium. The processing sub-circuit may read corresponding data from the storage medium when it is needed to be used later.

The processing sub-circuit in the display control circuit may be configured to perform various operations of the method of burn-in compensation for the display panel as in the method described above with reference to FIGS. 6 to 14, and the description thereof will not be repeated here.

According to different design requirements, the display control circuit may be implemented in the form of hardware (hard ware), firmware (firmware), software (program), or a combination of more of the three.

In the form of hardware, the above display control circuit may be implemented as a logic circuit on an integrated circuit. The related functions of the display control circuitry described above may be implemented as hardware using hardware description languages (e.g., Verilog HDL or VHDL) or other suitable programming languages. For example, the related functions of the display control circuit described above may be implemented in various logic blocks, modules, and circuits in one or more controllers, microcontrollers, microprocessors, application-specific integrated circuits (ASICs), digital signal processors (DSPs), field programmable gate arrays (FPGAs), and/or other processing units.

In the form of software and/or firmware, the related functions of the above-described display control circuitry may be implemented as programming codes. For example, the above-described display control circuitry is implemented in a general programming language (e.g., C, C++, or a combined language) or other suitable programming languages. The programming codes may be recorded/stored in a recording medium including, for example, a Read Only Memory (ROM), a storage device, and/or a Random Access Memory (RAM). A computer, a Central Processing Unit (CPU), a controller, a microcontroller or a microprocessor can read and execute the programming codes from the recording medium to achieve related functions. As the recording medium, a “non-transitory computer readable medium” can be used, and for example, a tape, a disk, a card, a semiconductor memory, a programmable logic circuit, or the like can be used. Further, the program codes may be supplied to the computer (or the CPU) via an arbitrary transmission medium (a communication network, a broadcast radio wave, or the like). The communication network is, for example, the Internet, wired communication, wireless communication or other communication medium.

Those skilled in the art will appreciate that various modifications and changes may be made to the structure of the disclosed embodiments without departing from the scope or spirit of the present disclosure. In view of the foregoing, it is intended that the present disclosure cover modifications and variations of the present disclosure that fall within the scope of the appended claims and equivalents thereof.

1. A method of burn-in compensation for a display panel, comprising:
performing, based on a first compensation value corresponding to a first display region of the display panel, a compensation calculation on input pixel data of the first display region in an input frame, to generate output pixel data of the first display region in a burn-in-compensated output frame, wherein the first compensation value is determined based on a first accumulated burn-in stress corresponding to the first display region;
sampling based on a first sampling period corresponding to the first display region, to obtain sampled pixel data of the first display region in a first sampled output frame from a plurality of burn-in-compensated output frames generated successively;
determining a first burn-in stress increment based on the sampled pixel data of the first display region in the first sampled output frame; and
generating a first updated accumulated burn-in stress based on the first accumulated burn-in stress and the first burn-in stress increment, or based on the first compensation value and the first burn-in stress increment, for updating the first sampling period.

2. The method according to claim 1, further comprising:
obtaining the first accumulated burn-in stress corresponding to the first display region, and determining, based on a first mapping table, the first compensation value corresponding to the first accumulated burn-in stress, wherein the first mapping table records a mapping relationship of a plurality of reference accumulated burn-in stresses corresponding to a plurality of reference compensation values.

3. The method according to claim 1, wherein determining the first burn-in stress increment based on the sampled pixel data of the first display region in the first sampled output frame comprises:
determining, based on the sampled pixel data of the first display region in the first sampled output frame, a first burn-in stress original increment; and
multiplying the first burn-in stress original increment by a first ratio to obtain the first burn-in stress increment, wherein the first ratio is positively correlated with a time length of the first sampling period.

4. The method according to claim 1, wherein generating the first updated accumulated burn-in stress based on the first accumulated burn-in stress and the first burn-in stress increment comprises:
adding the first accumulated burn-in stress and the first burn-in stress increment to obtain the first updated accumulated burn-in stress.

5. The method according to claim 1, wherein generating the first updated accumulated burn-in stress based on the first compensation value and the first burn-in stress increment comprises:
determining the first accumulated burn-in stress corresponding to the first compensation value based on a first mapping table, wherein the first mapping table records a mapping relationship of a plurality of reference accumulated burn-in stresses corresponding to a plurality of reference compensation values; and
adding the first accumulated burn-in stress and the first burn-in stress increment to obtain the first updated accumulated burn-in stress.

6. The method according to claim 1, further comprising:
determining, based on a second mapping table, an updated value of the first sampling period corresponding to the first updated accumulated burn-in stress,
wherein the second mapping table records a mapping relationship of a plurality of reference accumulated burn-in stresses corresponding to a plurality of sampling periods, and when the first accumulated burn-in stress changes to the first updated accumulated burn-in stress, the larger a variation magnitude of the first compensation value, the smaller the updated value of the first sampling period.

7. The method according to claim 1, wherein the first sampling period is a multiple of a time length of a frame, and output pixel data of the first display region in each output frame within the first sampling period results in a same or similar burn-in stress original increment.

8. The method according to claim 1, wherein the first accumulated burn-in stress and the first updated accumulated burn-in stress are represented and processed in a first number of data bits, and the method further comprises:
reading a stored value of the first accumulated burn-in stress having a second number of data bits from a storage medium and converting the stored value to a calculated value of the first accumulated burn-in stress having the first number of data bits, wherein the second number is less than the first number; and
converting a calculated value of the first updated accumulated burn-in stress having the first number of data bits to a stored value of the first updated accumulated burn-in stress having the second number of data bits, and storing the stored value of the first updated accumulated burn-in stress in the storage medium.

9. The method according to claim 1, wherein in a case where the first updated accumulated burn-in stress is generated based on the first compensation value and the first burn-in stress increment, the method further comprises:
generating a first updated compensation value based on the first compensation value and the first burn-in stress increment.

10. The method according to claim 9, wherein generating the first updated compensation value based on the first compensation value and the first burn-in stress increment comprises:
obtaining, based on the first compensation value and from a first mapping table, two reference compensation values between which the first compensation value is located, and obtaining two reference accumulated burn-in stresses corresponding to the two reference compensation values, wherein the first mapping table records a mapping relationship of a plurality of reference accumulated burn-in stresses corresponding to a plurality of reference compensation values;
determining a first compensation increment based on the first burn-in stress increment, the obtained two reference compensation values and the obtained two reference accumulated burn-in stresses; and
determining the first updated compensation value based on the first compensation value and the first compensation increment.

11. The method according to claim 9, comprising:
reading the first compensation value from a storage medium to perform the compensation calculation on the input pixel data of the first display region in the input frame; and
writing the first update compensation value to the storage medium.

12. The method according to claim 1, wherein performing, based on a first compensation value corresponding to a first display region of the display panel, a compensation calculation on input pixel data of the first display region in an input frame, comprises:
multiplying the first compensation value by an operating factor, to obtain an adjusted compensation value for the first display region, wherein the operating factor is associated with one or more of: a display panel attribute, an environmental impact factor, and a driving performance; and
generating the output pixel data in the first display region of the burn-in-compensated output frame, based on the adjusted compensation value for the first display region and the input pixel data of the first display region.

13. The method according to claim 3, wherein the first ratio is further associated with an operating factor,
wherein the operating factor is associated with one or more of: a display panel attribute, an environmental impact factor, and a driving performance.

14. The method according to claim 1, wherein the display panel further comprises a second display region,
wherein the method further comprises:
performing, based on a second compensation value corresponding to a second display region of the display panel, the compensation calculation on input pixel data of the second display region in the input frame, to generate output pixel data of the second display region in the burn-in-compensated output frame, wherein the second compensation value is determined based on a second accumulated burn-in stress corresponding to the second display region;
sampling based on a second sampling period corresponding to the second display region, to obtain sampled pixel data of the second display region in a second sampled output frame from the plurality of burn-in-compensated output frames generated successively;
determining a second burn-in stress increment based on the sampled pixel data of the second display region in the second sampled output frame; and
generating a second updated accumulated burn-in stress based on the second accumulated burn-in stress and the second burn-in stress increment, or based on the second compensation value and the second burn-in stress increment, for updating the second sampling period,
wherein the first sampling period and the second sampling period are set separately.

15. The method according to claim 14, wherein values of time lengths of the first sampling period and the second sampling period are factors/multiples of each other.

16. A display control circuit of a display panel comprising a processing sub-circuit configured to perform the method of claim 1.

17. A display device comprising:
a display panel; and
the display control circuit of claim 16 for controlling a display operation of the display panel.
